(19) United States
(12) Patent Application Publication
(10) Pub. No.: US 2011/0314683 A1
(43) Pub. Date: Dec. 29, 2011

(54) Power Tool, Particularly a Hand-Held Power Tool

(75) Inventors: Thilo Koeder, Gerlingen (DE); Joachim Platzer, Remseck-Hochberg (DE)

(73) Assignee: Robert Bosch GmbH, Stuttgart (DE)

(21) Appl. No.: 13/141,440

(22) PCT Filed: Oct. 22, 2009
(86) PCT No.: PCT/EP09/63903

§ 371 Date: Sep. 15, 2011

(30) Foreign Application Priority Data
Dec. 22, 2008 (DE) 102008055066.3

(51) Int. Cl. B23D 51/16; B23D 59/00; B23D 49/16

(52) U.S. Cl. 30/393; 173/217; 30/392; 173/1

(57) ABSTRACT

A power tool, particularly in the form of a keyhole saw, is provided with a sensor device that senses the position of the tool, in particular the reciprocating position of the saw blade in at least one of the reversal positions.

The invention relates to a power tool, particularly a hand-held power tool, as claimed in the preamble of claim 1, and also to a method for operating a power tool of this kind.

### PRIOR ART

Power tools of the abovementioned kind are known. DE 10 2006 052 808 A1 describes a power tool of this kind in its preferred refinement as a jigsaw with a plurality of expansion stages.

In a first expansion stage, the jigsaw is provided with a tool in the form of a saw blade which is driven only with a reciprocating movement and cannot be rotated. In a further expansion stage, for the so-called oscillating reciprocating-movement mode, an additional ability to pivot about a pivot axis which is transverse to the reciprocating-movement axis and to the plane of the saw blade is provided. Another, possibly further expansion stage makes provision for the saw blade to be able to rotate about a rotation axis which is parallel to the reciprocating-movement axis of said saw blade. This makes it possible to change the working direction by rotating the saw blade. This is used for the semiautonomous operation of jigsaws, for which the jigsaw is provided with a detection sensor system, particularly a camera, for observing the working line, and in which the saw blade, in its rotation position, is aligned with the working line to be followed, in a manner derived from the observation results obtained in this way. To this end, a computer-aided evaluation unit is arranged downstream of the sensor system which is formed by the camera, said evaluation unit driving the actuating drive for setting the rotation position of the saw blade by means of a control electronics system.

The large number of devices and sensor systems which are to be accommodated in and on the power tool as close as possible to the tool at least in the higher expansion stages of the tool create restricted space conditions. This is particularly also true of the camera, for which it is necessary to additionally ensure a clear view of the working region of the saw blade on the workpiece under normal operating conditions. Restrictions cannot always be avoided in this case. Furthermore, the various actuating options for the saw blade as a working tool also sometimes result in working situations which are critical, at least obstruct execution of actuating movements of the saw blade which are initiated by the power tool, and which can even lead to damage to the saw blade and/or to damage to the workpiece.

Similar problems also arise with other power tools, for example drills, hand-held circular saws, hand-held planing machines or routers.

### DISCLOSURE OF THE INVENTION

The invention is based on the object of expanding the spectrum of intervention options in the power tool during the operating process for a power tool of the described type in order to assist the user in respect of operator control and utilization of the power tool and also to ensure a problem-free operating process.

According to the invention, this is achieved by the features of claim 1. The claims which are dependent on said claim 1 and also the method according to the invention describe supplementary options.

According to the invention, an additional detection device for processing and/or operating parameters of the power tool is created by a sensor system which detects movements and positions of the tool. This provides a variety of intervention and/or actuating options.

For example, in the case of jigsaws, it is thus possible to activate the sensor system, which is in the form of a camera and is provided for observing the working region, only when the saw blade and the saw blade holder, which is provided in conjunction with said saw blade for the reciprocating-movement drive, at least largely expose the view of the working region of the tool, this being the case particularly in the upper reversal position of the reciprocating-movement drive. It is therefore possible to deliberately dispense with detection of images in the reciprocating-movement regions in which the viewing conditions for the camera are poor, and thus to also accordingly reduce the amount of signals which are to be processed.

Furthermore, rotational movements are critical for the saw blade under certain circumstances, particularly when an oscillating reciprocating movement is enabled with engagement of the saw blade in the workpiece. The detection of the upper reversal position according to the invention makes it possible for corrections to the saw blade to be made, with the oscillating reciprocating movement enabled, only when the saw blade is not in sawing engagement with the workpiece as said saw blade is moved downward. This ensures that the actuating forces on the saw blade on account of the strong forward pushing motion are not excessively high and possibly also adversely affect the accuracy in respect of following the path.

Furthermore, the corresponding detection of the reversal positions can also be used within the scope of the invention for control purposes, for example for measuring and setting the number of reciprocating movements.

Detection of the respective reversal position is possible in a simple manner within the scope of the invention particularly for the upper reversal position which is of particular interest, with the corresponding sensor system being arranged on the power tool in association with the upper reversal position. However, the reciprocating-movement position may possibly also be detected in a corresponding manner by means of sensor systems which are associated with the reciprocating-movement drive and are provided on the reciprocating-movement drive, particularly on the reciprocating-movement rod. A sensor system for respectively detecting the reversal position can expediently be formed by a Hall sensor.

A further option is that of indirect detection of the respective reciprocating-movement position by detecting fluctuations in the motor current in the respective reversal position or positions. Therefore, the invention particularly also provides a method for detecting at least one reversal position of the reciprocating-movement drive as an operating and/or control parameter for the power tool, it being possible to generate actuating and control signals for further operating processes from said method in an advantageous manner.

Further advantages and expedient embodiments can be found in the further claims, the description of the figures and the drawings, in which:

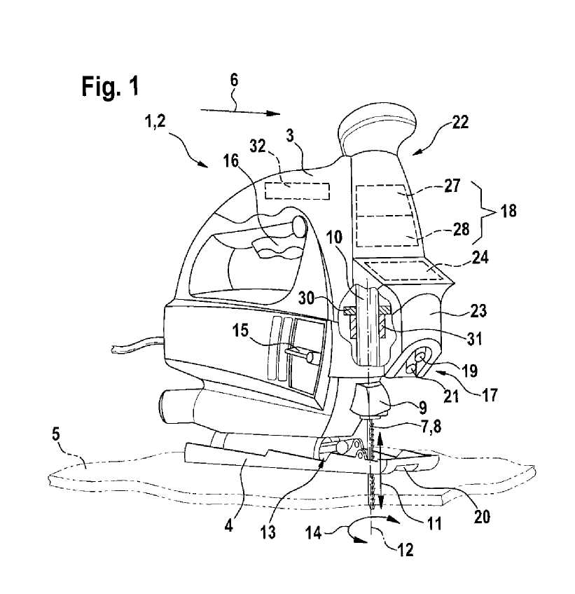

FIG. 1 shows a schematic illustration of a power tool according to the invention in the form of a hand-held, electrically driven jigsaw which has, on the front, a sensor system for observing the working region of its saw blade on the workpiece, and

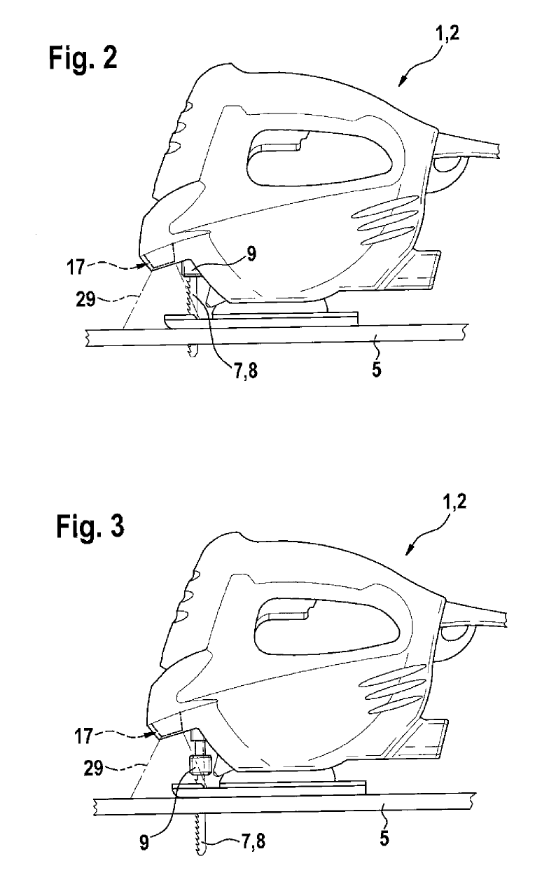

FIGS. 2 and 3

show schematic illustrations of a jigsaw according to FIG. 1, with FIG. 2 showing the jigsaw with the saw blade, which moves in a reciprocating manner, raised into the upper reversal position and therefore the sensor system having a largely clear view of the working region of the saw blade, while FIG. 3 illustrates a corresponding situation with the saw blade extended into the lower reversal position and therefore the field of view of the sensor system being partially restricted by the saw blade and its holder.

FIG. 1 shows a jigsaw 2 as an example of a hand-held power tool 1 according to the invention. The housing 3 of said jigsaw is supported on a workpiece 5, such that it can move, by means of a base plate 4. In its front region relative to the working direction 6, the jigsaw 2 is provided with a saw blade 8 as a working tool 7. The saw blade 8 is held in a tool holder 9 which is situated in the junction from the saw blade 8 to a reciprocating-movement rod 10. The reciprocating-movement rod 10 is only schematically indicated and can be adjusted so as to move in a reciprocating manner in the direction of the arrow 11 by means of a drive (not illustrated) together with the saw blade 8. Together with the saw blade 8, the reciprocating-movement rod 10 can also be rotated about a rotation axis 12, which extends in the direction of its reciprocating-movement axis, by means of an actuating drive (only schematically illustrated) on the power tool. A drive apparatus 13, which is situated toward the rear in relation to the saw blade 8 and by means of which the saw blade 8 can be pivoted about a pivot axis (not illustrated) which runs transverse to the rotation axis and also transverse to the working direction 6, is also indicated in FIG. 1.

The jigsaw 2 can be operated in various modes of operation on account of the design described above. One of said modes of operation is the normal operating mode with the saw blade remaining oriented in the working direction 6. A further manner of operation is the so-called oscillating reciprocating-movement mode in which the saw blade 8 is moved in an oscillating manner about a pivot axis (not shown) which runs transverse to the rotation axis 12 by means of the drive apparatus 14 in a manner superimposed on the reciprocating movement according to arrow 11.

In a third manner of operation, use is made of the ability of the saw blade 8 to rotate about the rotation axis 12 and the jigsaw 2 can be used as a so-called “scrolling jigsaw” and therefore can be operated as a semiautonomous jigsaw 2. This means that the user holding the jigsaw 2 essentially only supports the jigsaw in a manner aligned roughly with a working line which is to be followed and pushes the power tool forward, but the exact positioning of the jigsaw 2 aligned with and corresponding to said working line is performed by the rotational adjustment and alignment of the saw blade 8 with the working line.

The individual modes of operation can be set by means of a switching device 15. A switching arrangement 16 for switching on and switching off the jigsaw 2 is also indicated. In particular, semiautonomous operation of the jigsaw 2 is not possible without an observation device 17 for a working line which is to be followed in each case, and corresponding auxiliary devices 18 are required downstream of the observation device 17 in order to enable semiautonomous operation of the jigsaw 2, taking into consideration the conditions on the workpiece which are detected by means of the observation device 17, for example the working line which is to be detected in particular.

To this end, the observation device 17 comprises a sensor system 19 which is formed particularly by a camera and is oriented primarily toward a detection area through which the saw blade 7 passes and which is situated in the region of a cutout 20 (only partly visible) which is provided in the base plate 4 so as to surround the saw blade 8. An illumination device 21 is also expediently oriented toward the cutout 20 and the area surrounding said cutout, said illumination device preferably being situated in the area surrounding the sensor system 19 and, like this sensor system, being provided on the bottom of a projection 23 which projects beyond the front 22 of the housing. A display 24 is expediently provided on the top of the projection 23. The auxiliary devices 18 symbolically illustrated on the front 22 comprise a computer unit 27 and a drive electronics system 28 by means of which primarily the results of the observation device 17 are converted into actuating and control commands and possibly also instructions which are displayed to the user on the display 24.

FIG. 1 already shows that the detection area which is situated in the region of the cutout 20 is optically detected by means of the sensor system 19 under very restrictive conditions since the projection 23 which protrudes beyond the saw blade 8 at the front so as to engage over the base plate 4 already has to be kept as short as possible so that the user can, as is necessary, see the working field. A conical observation region 29, in which the saw blade 8 and the tool holder 9 additionally still move, is associated with this, as shown in FIGS. 2 and 3. The result of this is that a not insignificant portion of the detection area is covered, at least in the lower reversal position of the saw blade 8, which is driven with a reciprocating movement, by means of said saw blade and primarily by means of the tool holder 9, and therefore cannot be detected by means of the sensor system 19 either. Therefore, the camera sometimes operates to no purpose in terms of results and in these working phases creates only unnecessary evaluation and post-processing operations.

This can be avoided according to the invention by the camera being controlled as a function of the reciprocating-movement position of the saw blade 8 and, respectively, the tool holder 9 and being activated only when the tool holder 9 has moved to an upper reciprocating-movement position, and therefore the view of the saw blade 8 no longer is restricted. The sensor system 19 in the form of the camera is accordingly actuated by means of a sensor system 30 which is illustrated, by way of example, in association with a mount 31 on the housing. For the sake of simplicity, the sensor system 30 is illustrated in the form of a sensor ring by means of which the upper reversal position of the reciprocating-movement rod 10 is detected. A corresponding control signal is used by means of the control unit 26 to trigger recording of a camera image in the reversal position or in the region of the reversal position when the sensor system 19 has a clear view of the detection area. A Hall sensor can, for example, be used as the sensor 30.

An electromotive drive unit 32 is provided for the reciprocating-movement drive of the saw blade 7, said electromotive drive unit being indicated only schematically in FIG. 1. The reciprocating-movement rod 10 can be driven, for example so as to impart eccentric drive in a known manner, by means of the drive unit; however, other drive forms are also feasible for the reciprocating-movement rod 10. Said drive forms share the common feature that there is a change in the torque profile in the reversal positions of the reciprocating-movement drive and this change can be detected by a sensor, specifically preferably and particularly by means of the current consumption by the drive arrangement 32. A control signal can likewise be obtained in a manner derived from this, recording of an image of the detection region being triggered by means of said control signal in the region of the upper reversal position of the reciprocating-movement drive.

Detection of a respective reversal position of the reciprocating-movement drive, particularly the upper reversal position, can still be used within the scope of the invention for detecting and/or influencing further operating parameters, for example for activating specific device functions only during operation—reversal positions only then being provided—or for imparting information about actual operating parameters, for example about the number of reciprocating movements, to the user. This also provides the option of replacing signals containing corresponding information, which signals have been obtained in a different way to date, with the output signal which is obtained as a function of the reciprocating-movement position according to the invention. If the number of reciprocating movements is detected in the manner according to the invention, a respectively amended number of reciprocating movements can also be set taking into account other values, for example with knowledge of the material characteristic values of the workpiece 5 to be processed in each case.

Therefore, overall, the solution according to the invention, that of detecting movements and/or positions of a respective tool and obtaining processing parameters derived from them, provides a simple solution which can be implemented without a substantial amount of additional expenditure.

1. A power tool, comprising a working tool which is configured to act on a workpiece and is driven by an electric motor, and having a detection device for processing parameters, wherein the detection device includes a sensor system configured to detect movements and/or positions of the working tool.

2. The power tool as claimed in claim 1, wherein:
the power tool includes a jigsaw,
the jigsaw is configured to be driven with a reciprocating movement, and
the sensor system is configured to detect at least one of the reversal positions of the working tool.

3. The power tool as claimed in claim 2, wherein the sensor system is arranged in relation to the working tool in a position which detects an upper reversal position of said working tool.

4. The power tool as claimed in claim 3, wherein:
the working tool includes a reciprocating-movement rod drive, and
the sensor system is arranged in relation to the reciprocating-movement rod drive in a position which detects the upper reversal position of said working tool.

5. The power tool as claimed in claim 4, wherein the sensor system includes a Hall sensor.

6. The power tool as claimed in claim 3, wherein:
the working tool includes a reciprocating-movement rod drive, and
the sensor system is provided on the reciprocating-movement rod drive.

7. The power tool as claimed in claim 2, wherein the sensor system detects at least one reversal position by way of a change in the torque profile of the electromotive reciprocating-movement drive in the region of the reversal position.

8. The power tool as claimed in claim 2, wherein the sensor system detects a change in the current consumption by the reciprocating-movement drive in at least one reversal position.

9. The power tool as claimed in claim 1, wherein the power tool is includes a jigsaw configured to be operated in an oscillating reciprocating-movement mode, and wherein the power tool is configured so that the position of the saw blade of said jigsaw is adjustable only during the reciprocating movement starting from the upper reciprocating position.

10. A method for operating a power tool having a working tool which acts on a workpiece and can be adjusted between an upper and a lower reversal position by way of an electromotive reciprocating-movement drive, and having a detection sensor system on the power tool, wherein at least one reversal position of the tool is detected by way of the detection sensor system, and a signal which corresponds to this reversal position is provided as an output signal.

11. The method as claimed in claim 10, wherein the output signal is used for detecting and/or controlling the number of reciprocating movements.

12. The method as claimed in claim 11, wherein the output signal is used for controlling the reciprocating-movement drive and/or actuating devices which act on the working tool.

13. The method as claimed in claim 10, wherein:
the power tool includes a jigsaw and an observation device,
the observation device is aligned with the working line to be followed by the saw blade and is in the form of a camera, and
the observation device is switched on by way of the output signal for the reciprocating-movement region starting from the reversal position.
